(19) United States
(12) Patent Application Publication
(10) Pub. No.: US 2019/0236038 A1
(43) Pub. Date: Aug. 1, 2019

(54) BUFFERED INTERCONNECT FOR HIGHLY SCALABLE ON-DIE FABRIC

(71) Applicants: Swadesh Choudhary, Mountain View, CA (US); Bahaa Fahim, Santa Clara, CA (US); Doddaballapur Jayashimha, Saratoga, CA (US); Jeffrey Chamberlain, Tracy, CA (US); Yen-Cheng Liu, Portland, OR (US)

(72) Inventors: Swadesh Choudhary, Mountain View, CA (US); Bahaa Fahim, Santa Clara, CA (US); Doddaballapur Jayashimha, Saratoga, CA (US); Jeffrey Chamberlain, Tracy, CA (US); Yen-Cheng Liu, Portland, OR (US)

(21) Appl. No.: 16/227,364

(22) Filed: Dec. 20, 2018

(51) Int. Cl. G06F 13/20; G06F 13/40

(52) U.S. Cl. CPC G06F 13/20; G06F 13/4027

(57) ABSTRACT

Buffered interconnects for highly scalable on-die fabric and associated methods and apparatus. A plurality of nodes on a die are interconnected via an on-die fabric. The nodes and fabric are configured to implement forwarding of credited messages from source nodes to destination nodes using forwarding paths partitioned into a plurality of segments, wherein separate credit loops are implemented for each segment. Under one fabric configuration implementing an approach called multi-level crediting, the nodes are configured in a two-dimensional grid and messages are forwarded using vertical and horizontal segments, wherein a first segment is between a source node and a turn node in the same row or column and the second segment is between the turn node and a destination node. Under another approach called buffered mesh, buffering and credit management facilities are provided at each node and adjacent nodes are configured to implement credit loops for forwarding messages between the nodes. The fabrics may comprise various topologies, including 2D mesh topologies and ring interconnect structures. Moreover, multi-level crediting and buffered mesh may be used for forwarding messages across dies.

### BACKGROUND INFORMATION

During the past decade, new generations of processors have been introduced with increasing numbers of processor cores. The use of more processor cores enables processor performance to scale, overcoming the physical limitations that began to limit single-core processor performance in the mid-2000's. It is forecast that future processors will have even more cores.

Multi-core processor architectures have to address challenges that either did not exist or were relatively easy to solve in single-core processors. One of those challenges is maintaining memory coherency. Today's processor cores typically have local L1 (Level 1) and L2 (Level 2) caches, with a distributed L3 or Last Level Cache (LLC). When processes that share data are distributed among multiple processor cores, there needs to be a means of maintaining memory coherency among the various levels of cache forming the cache hierarchy implemented by the processor. This may be accomplished by using one of several cache coherency protocols, such as MESI (Modified, Exclusive, Shared, Invalid). Under the MESI cache coherency protocol, when a processor (or core) makes a first copy of a memory line from main memory to its local cache, a mechanism is employed to mark the cache line as Exclusive (E), such that another core attempting to access the same memory line knows it does not have exclusive access to the memory line. If two or more cores have copies of the same cache line and the data in the line has not been changed (i.e., the data in the caches is the same as the line in main memory), the cache lines are in a shared (S) state. Once a change is made to the data in a local cache, the line is marked as modified (M) for that cache, and the other copies of the line are marked as Invalid (I), since they no longer reflect the changed state of data for the line. The state returns to Exclusive once the value in the modified cache line is written back to main memory. Such coherency protocols are implemented by using cache agents that exchange messages to implement the cache coherency protocol, such as requests, responses, snoops, acknowledgements or other types of messages.

For example, some previous generations of Intel® Corporation processors employed a ring interconnect architecture under which messages are passed along the ring (in both directions) between ring stop nodes on the ring (see discussion of FIG. 11 below). The ring stop nodes are coupled to various components in the System on a Chip (SoC) processor architecture, and various agents are implemented at the ring stop node to handle the messages, such as cache agents (for some of the agents). At a given ring stop node, messages may be 1) removed from the ring (if the message destination may be reached from that node stop); 2) inserted onto the ring (if there is an available slot during a given cycle); or 3) forwarded to a next ring stop node on the ring (most common).

While the ring interconnect architecture worked well for several generations, it began running into scaling limitations with increasing core counts. For example, consider that with a linear increase in core count, the amount of memory coherency messages increases (somewhat) exponentially. In addition to the increased level of message traffic on the ring, performance was diminished as the number of cycles to access a cacheline from another cache associated with a core on the other side of the ring increased when additional cores (and corresponding nodes) were added to the ring.

In more recent generations, processor designs at Intel® have transitioned from the ring interconnect architecture to a mesh interconnect architecture. Under a mesh interconnect, an interconnect fabric is used to connect all agents (cores, caches, and system agents, such as memory and I/O agents) together for routing messages between these agents. For example, rather than nodes arranged around a single large ring, the nodes are arranged in an X-Y grid, hence the name “mesh” interconnect. At the same time, aspects of the ring interconnect concept are still used, as groups of nodes (also referred to herein as tiles) are interconnected using smaller rings on a column and row basis, such that the mesh interconnect is structurally a two-dimensional array of (smaller) ring interconnects.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram illustrating a mesh interconnect fabric under which tiles in rows and columns are interconnected with uni-directional ring interconnect structures;

FIG. 1a is a diagram illustrating a mesh interconnect fabric under which tiles in rows and columns are interconnected with bi-directional ring interconnect structures;

FIG. 2 is a diagram illustrating an example of end-to-end crediting, according to one embodiment;

FIG. 3 is a diagram illustrating a first example of multi-level crediting including a first vertical forwarding path segment followed by a second horizontal forwarding path segment;

FIG. 3a is a diagram illustrating a second example of multi-level crediting including a first horizontal forwarding path segment followed by a second vertical forwarding path segment;

FIG. 3b is a diagram illustrating a third example of multi-level crediting using a multi-die architecture including a first vertical forwarding path segment followed by a second horizontal forwarding path segment, and then a third horizontal forwarding path segment across a die boundary;

FIG. 4 is a diagram illustrating buffer and credit management components on source agent tiles, a turn tile, and destination agent tiles, according to one embodiment

FIG. 5 is a diagram illustrating an example of forwarding a credited message from a source to a destination using a buffered mesh, according to one embodiment;

FIG. 6 is a diagram illustrating a buffer and credit management configuration for an internal tile, according to one embodiment;

FIG. 7 is a diagram of a logic circuit for forwarding a message in a left to right horizontal direction, according to one embodiment;

FIG. 8 is a diagram of a logic circuit for forwarding a message in an up to down vertical direction, according to one embodiment;

FIG. 9 is a flowchart illustrating operations and logic for implementing source throttling, in accordance with one embodiment;

FIG. 10 is a schematic diagram of a computer system including an SoC processor having a plurality of tiles arranged in a two-dimensional array interconnected via mesh interconnect on-die fabric, according to one embodiment;

FIG. 11 is a schematic diagram of a multi-socketed computer system include a plurality of SoC processors employing a bi-directional ring interconnect structure, according to one embodiment;

FIG. 12 is a graph illustrating the scaling performance of various crediting schemes disclosed herein; and

FIG. 13 is a table comparing end-to-end crediting, multi-level crediting, and buffered mesh for power, topology dependence, QoS, idle latency, and loaded latency and throughput.

### DETAILED DESCRIPTION

Embodiments of buffered interconnects for highly scalable on-die fabric and associated methods and apparatus are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

The introduction of mesh interconnect architectures addressed some of the limitations of the prior-generation ring interconnect architectures, but also present new challenges. To manage traffic in the fabric, the mesh interconnect architectures use both credited and non-credited messages. Credited messages are non-bounceable on the fabric. Credited messages are also guaranteed to sink at the destination, since the source acquires credits into the destination buffer (requests), or the destination is able to unconditionally accept messages (e.g. responses, credits). In contrast, Non-Credited messages are bounceable on the interconnect based on flow control mechanisms at the destination that could prevent accepting messages. There are various reasons that destinations might not be able to accept/sink messages without an advance warning, which include rate mismatch (clock ratio alignment on core/uncore boundaries), and buffer full conditions—e.g. a CPU core request buffers at the cache agent which is unable to accept the request from all core sources.

Mesh interconnects are designed to limit bouncing. Bouncing uses slots on the ring which are shared amongst requests and poses fairness issues. Significant efforts are made to optimize mesh latency, especially the idle latency. The mesh is heavily RC (resistance, capacitance) dominated with a very small number of gates for basic decode. Various techniques are used to optimize this latency.

The mesh interconnect targeting server architectures must be capable of scaling to very large configurations with hundreds of agents and provides a significant amount of interconnect bandwidth at a low latency. Additionally, there is an increasing need for more bandwidth from each source. Current techniques to buffer credited messages at destinations a priori causes scalability issues because of the large buffering requirements.

In addition, scaling to large mesh interconnects with credited buffers at destinations may no longer be feasible for the following reasons:
1. The destination agent's ingress micro-architecture does not provide good scalability to isolate latency-critical paths from the effects of buffer sizes.
2. Multiple solutions to improve the micro-architecture exist; however these solutions introduce complexity, and will not resolve area/power impacts due to larger ingress buffers.
3. The Caching and Home Agent (CHA) destination also has credited ingress buffers that are not highly scalable and have been growing for performance reasons. As the number of agents requesting caching grows, and per agent performance also scales, the growth of these buffers is exponential with a destination-based crediting scheme. Moreover, the number of instances of CHA are also growing to scale performance, which adds further complexity.
4. The Uncore is becoming increasingly power/area challenged. This requires designers to investigate a direction that limits overall buffering requirements, even if the design is able to scale for a large number of credits and converge on target frequencies.
5. Current and future trends towards die splitting and/or stacking impose additional latencies, which require deeper buffers. Most of these buffers are not used in typical CPU operation and are wasting power and area.
6. Bouncing also uses slots on the ring that are shared with other requests and can cause bandwidth degradation or fairness issues.
7. Current destination buffered based approaches are not very modular. These approaches are not compatible with late topology changes to the SoC design to account for adjusting market needs, which result in severe disruption in IPs with respect to re-evaluating buffer sizes across all the agents in the system and invariably lead to performance issues.

In accordance with aspects of the embodiments now disclosed, several of the foregoing problems and issues are addressed by managing flow control of messages at intermediate points in the fabric, rather than at just the endpoints of the messages. The principles and teaching presented herein offer a continuum of available schemes that can be mixed and matched with each other and work seamlessly, depending on the performance/cost/area requirements of different transaction or agent types in SoC architectures. In addition, further novel concepts are introduced relating to implementation specifics (e.g., source throttling, credit management, etc.) and their application to coherency fabrics, in particular, which offer a path for scaling future processor architectures.

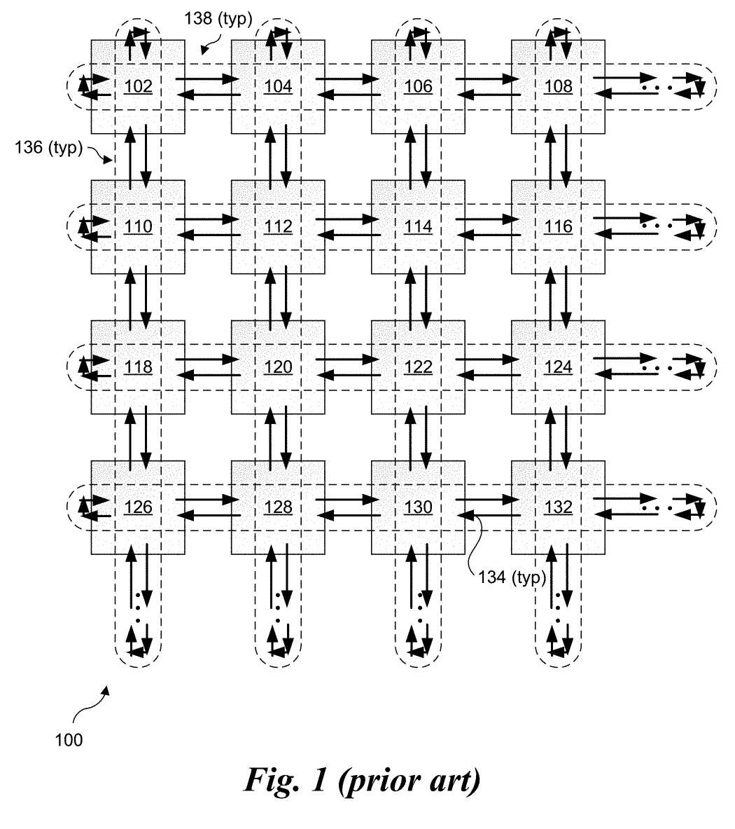

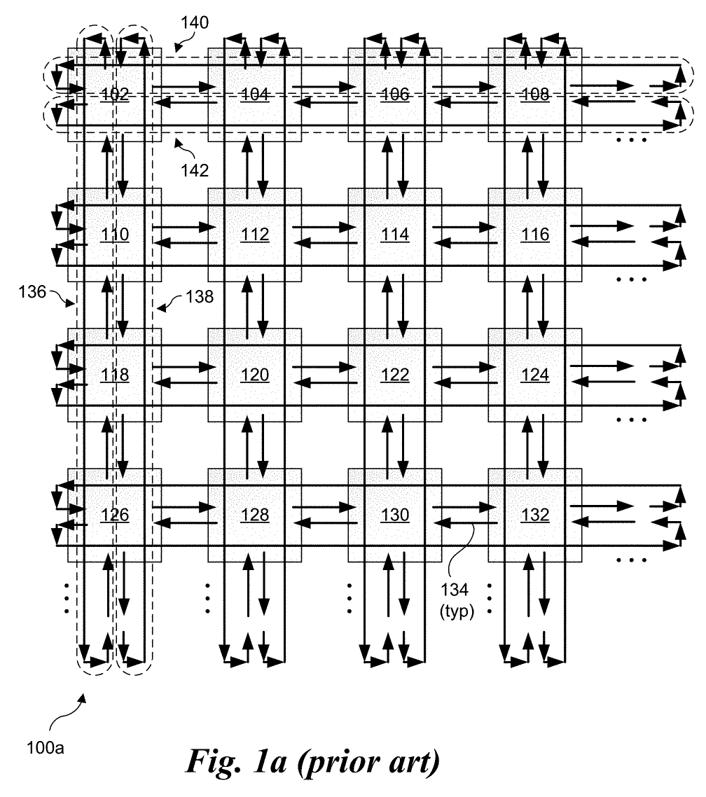

The following embodiments are generally described in the context of the mesh architecture 100 of FIG. 1, which shows the interconnects between sixteen “tiles” 102, 104, 106, 108, 110, 112, 114, 116, 118, 120, 122, 124, 126, 128, 130, and 132, wherein each arrow represents a uni-directional interconnect link 134 (also referred to herein as a link segment). For simplicity, only sixteen tiles are shown in the Figures herein; the ellipses to the right and below the sixteen tiles are to indicate the number of rows and columns may (and generally will) be greater than four. As further illustrated by ovals 136 and 138, groups of tiles in the same row or column are interconnected via a respective ring interconnect. The ring interconnect structures support bi-direction interconnections between pairs of tiles, and enable messages to be forwarded in any of the directions depicted in FIG. 1. Collectively, the interconnect links make up the mesh interconnect fabric.

Tiles are depicted herein for simplification and illustrative purposes. Each of tiles 102, 104, 106, 108, 110, 112, 114, 116, 118, 120, 122, 124, 126, 128, 130, and 132 is representative of a respective IP (intellectual property) block or a set of related IP blocks or SoC components. For example, a tile may represent a processor core, a combination of a processor core and L1/L2 cache, a memory controller, an IO (input-output) component, etc. Each of the tiles may also have one or more agents associated with it, as described in further detail below.

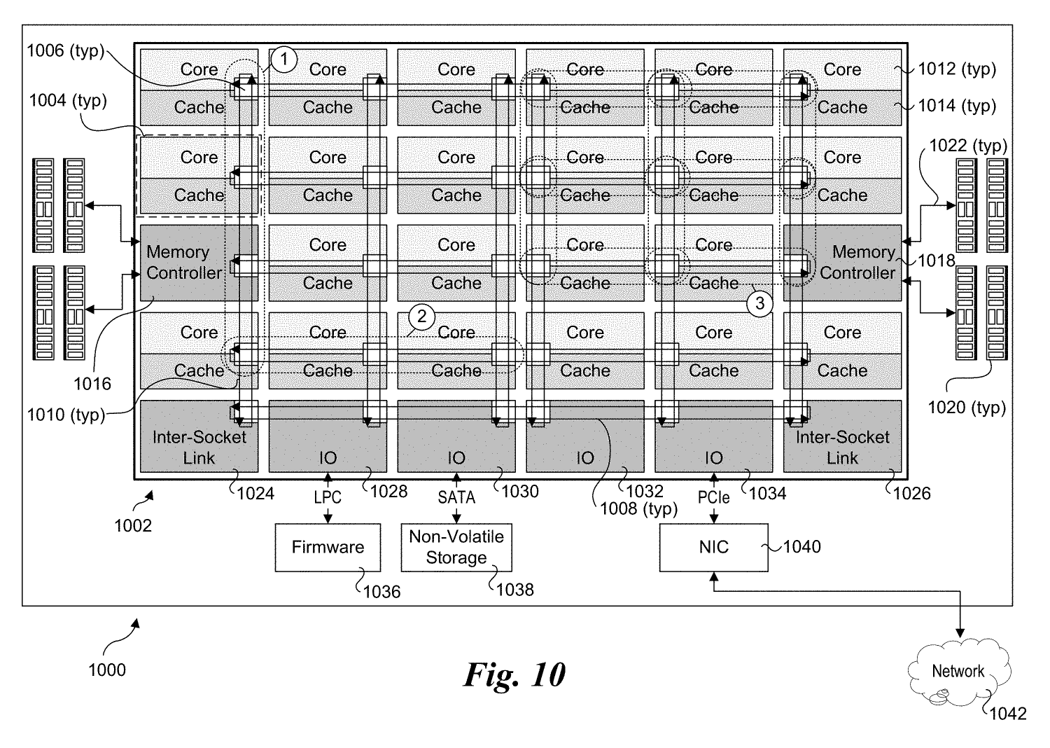

Each tile includes an associated mesh stop node, also referred to as a mesh stop, which are similar to ring stop nodes for ring interconnects. Some embodiments may include mesh stops (not shown) that are not associated with any particular tile, and may be used to insert additional message slots onto a ring, which enables messages to be inserted at other mesh stops along the ring; these tiles are generally not associated with an IP block or the like (other than logic to insert the message slots). FIG. 10 (discussed below) illustrates an example an SoC Processor showing tiles and their associated mesh stops. In other Figures herein, just the tiles are shown; however, it will be understood that those tiles are coupled to a mesh stop or have a mesh stop integrated with other circuitry for the tile.

Under the configuration of FIG. 1a, the tiles in a given column or row are interconnected by a pair of clockwise and counter-clockwise ring interconnects, as depicted by ovals 140 and 142 for the first row of tiles, and ovals 144 and 146 for the first column of tiles. The pairing of clockwise and counter-clockwise ring interconnects operates as a bi-directional ring interconnect, which enables packets to be circulated in both directions, as opposed to the uni-directional ring interconnects shown in FIG. 1.

It I noted that embodiments of a mesh architecture similar to those shown in FIG. 1 or FIG. 1a may be implemented without using column- and row-wise ring interconnect structures, and the use of such ring interconnect structures is merely exemplary and not to be limiting. As with interconnect meshes of FIGS. 1 and 1a, under such embodiments each pair of adjacent nodes is interconnected by a bi-directional pair of links.

For illustrative purposes, the mesh interconnect configuration of FIG. 1 (with the ends of the rings removed) will be used in subsequent drawing Figures herein to avoid crowding. It will be understand that other interconnect mesh configurations may be implemented in a similar manner, including embodiments employing bi-directional ring interconnects, as well as embodiments that do not employ ring interconnects.

Each of the arrows depicted between the tiles in the Figures herein are illustrative set of physical pathways (also referred to as sets of “wires”) over which messages are transferred using a layered network architecture. In some embodiments, separate sets of wires may be used for different message classes, while in other embodiments, two or more message classes may share the same set of wires. In some embodiments, the layered network architecture includes a Physical (PHY) layer (Layer 1), a Link layer above the PHY layer (Layer 2), and a Protocol Layer above the Link layer that is used to transport data using packetized messages. Various provisions, such as ingress and egress buffers at respective ends of a given uni-directional link are also provided at the tiles; to avoid clutter, the ingress and egress buffers are generally not shown in most of the Figures herein, but those skilled in the art will recognize that such buffers would exist in an actual implementation.

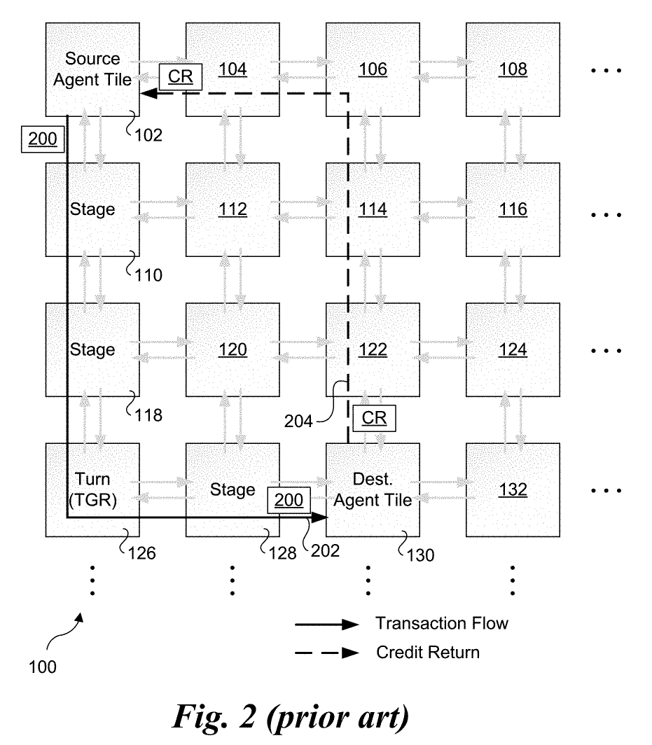

Examples of three schemes for forwarding credited messages are shown in FIGS. 2, 3, 3a, and 5. Under each approach, a message is permitted to make forward progress from a source to a destination only after it has acquired a requisite number of credits. The use of credits and credit returns for message flows is a practice that is well-known in the art; accordingly, some of the details of how credits are allocated and/or are otherwise used are not included in this detailed description, as they are outside the scope of this disclosure.

End-to-End Crediting

FIG. 2 illustrates an example of end-to-end crediting, which is a conventional approach that is currently used in various types of interconnect fabric architecture, including but not limited to mesh architectures. Under end-to-end crediting, Protocol Layer credits are managed between the source and the destination tiles (or mesh stops) on a pair-wise basis. For cases where multiple message classes are sharing the same physical channel, protocol layer credits must guarantee deadlock free forward progress (allowing different message classes to bypass each other based on the rules defined by the protocol). Link Layer credits also may be required for credited messages. These are unaware of the message class associated with the transactions and are present to manage rate mismatches between different sections of the fabric. Rate mismatch can occur for several reasons; some examples include frequency mismatches, time-multiplexing of the physical link between different sources, and power management related backpressures. A source that has acquired a credit for a destination agent is ensured progress along the routing path until it reaches the destination. In the example shown in FIG. 2, tile 102 is a source agent tile that is sending a message to tile 130, which is the destination agent tile. Each of tiles 110, 118, 128 are labeled as stage tiles, which are mesh stops at intermediate stages along the overall forwarding path. Meanwhile, tile 126 is labeled as a ‘Turn’ tile. As depicted in FIG. 2, a transaction message 200 originating at source agent tile 102 is forwarded along a transaction flow path 202, which traverses stage tiles 110, 118, Turn tile 126, and stage tile, 128. Upon receiving transaction message 200, in the illustrated embodiment destination agent tile 130 deducts the number of credits that were allocated for transaction message 200, and returns a credit return message ‘CR’ indicating the number of credits back to source agent tile 102, as depicted by a credit return path 204, which traverses tiles 122, 114, 106, and 104. As an option, credits for multiple messages may be combined in a single credit return message, which may help in reducing traffic. It is further noted that credits may be returned in transaction messages, as well as separate credit return messages.

Generally, under end-to-end crediting, transaction messages and credit returns are forwarded along paths that use the minimum number of turns (referred to as “dimension-ordered routing”), although this isn't a strict requirement. This results in certain tiles, such as stage tile 126, having to forward more traffic than other tiles. For example, the forwarding paths for messages originating from agents at tiles 110 and 118 would also be forwarded through stage tile 126. As a result, these tiles may need to support additional buffering in order to not bounce credited messages. Also, forwarding paths that traverse these tiles may have greater latencies, since only one message may be forwarded along a given link segment during a given cycle.

Another drawback to the end-to-end crediting scheme is that source agents need to have separate credits (as associated means for tracking such credits) for each destination agent they send transaction messages to. Allocation of such credits may also involve additional message traffic, depending on how credits are allocated for a given implementation.

Multi-Level Crediting

Assume that dimension-ordered routing is implemented for forwarding messages over the mesh interconnect, such as shown in FIG. 2. As shown in this example, transaction message 200 is forwarded for the source to the destination completely along a vertical (V) path first and then completely in the horizontal (H) direction. Hence, messages have at most one turn in traversing from the source to the destination tile.

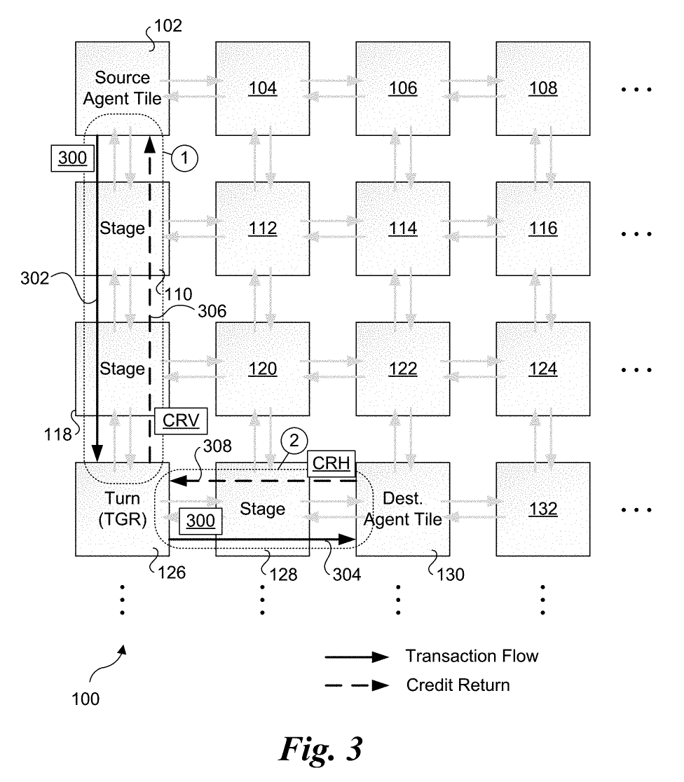

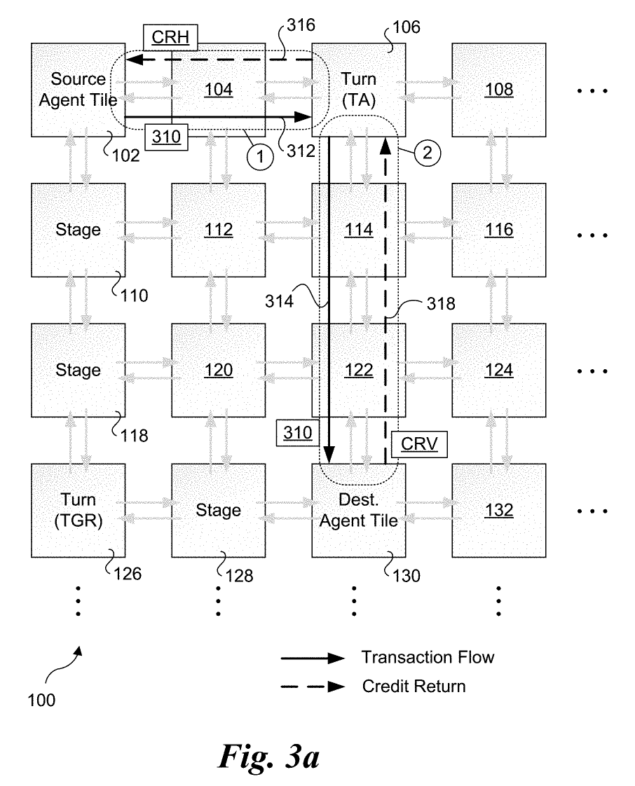

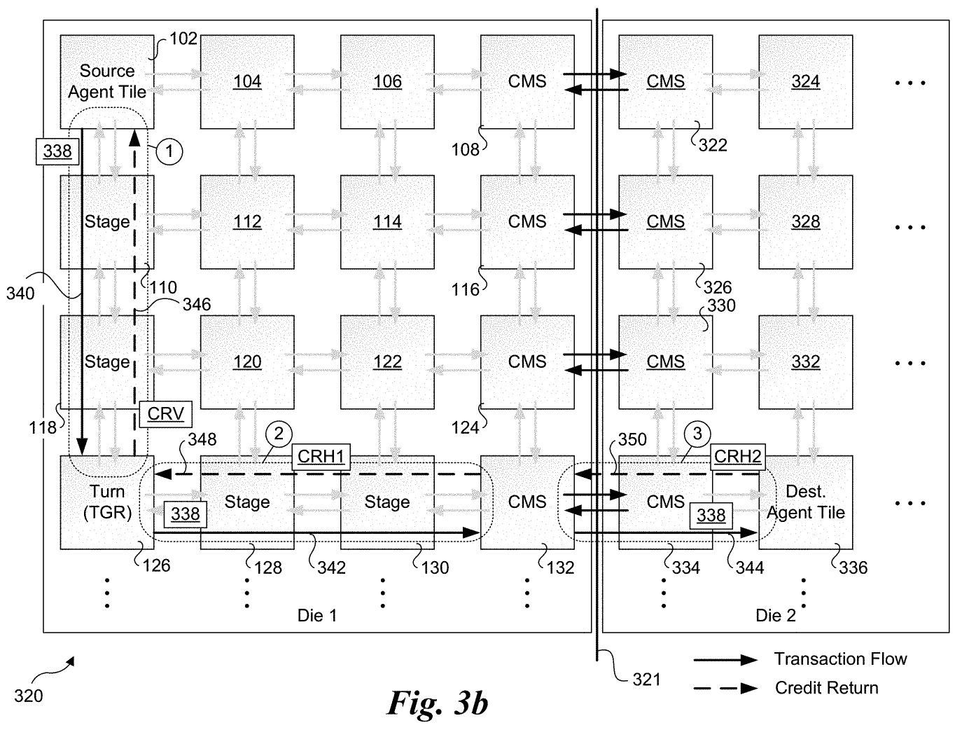

Multi-level crediting leverages dimension-ordered routing by dividing the forwarding path into separate vertical and horizontal segments. An example of this is illustrated in FIG. 3. As shown, a transaction message 300 originating from source agent tile 102 is forwarded along a first segment comprising a vertical forwarding path 302 to tile 126, which is implemented as a Turn tile. Transaction message 300 is then forwarded along a second segment comprising a horizontal forwarding path 304 from Turn tile 126 to destination agent tile 130, where the message “sunk” (i.e., removed from the ring and stored on the destination agent tile or otherwise stored in a buffer associated with the destination tile agent).

It is noted that while forwarding a transaction message from a source agent to a destination agent may be along separate vertical and horizontal forwarding path segments, the overall forwarding is coordinated at the Turn tile. There are multiple ways this may be implemented, such as forwarding a transaction message in a single packet with a destination address of the destination agent tile. When the packet containing the transaction message reaches a Turn tile, logic implemented in the Turn tile inspects the packet and determines that the destination address corresponds to a tile in its row. The packet is then forwarded to the destination agent tile via a second horizontal path segment. Alternatively, an encapsulation scheme may be implemented under which separate packets encapsulating the same message are used to respectively forward the message along the vertical and horizontal path segments. Under this approach, source agents could keep forwarding information that would map destination agent addresses to the Turn tiles used to reach the destinations. The source agent would then send a first packet having the Turn tile address as its destination address. Upon receipt, in one embodiment logic in the Turn tile could inspect the packet (e.g., the packet header), observe that the encapsulated message has a destination of one of the tiles in the Turn tile's row, change the destination address of the packet to the address of that destination tile, and forward the packet along a horizontal path to the destination tile. Alternatively, the message could be de-encapsulated at the Turn tile, and a second packet could be generated at the Turn tile that encapsulates the message, with the second packet being forwarded along the horizontal path to the destination tile.

The handling of credit returns under multi-level crediting is different than under end-to-end crediting. Rather than returning credits from a destination agent back to a source agent, credits are managed on a per forwarding path-segment basis; in the example of FIG. 3, separate credit returns are implemented for the individual horizontal and vertical path segments. For example, under the embodiment illustrated in FIG. 3, in response to receiving transaction message 300 from source agent tile 102, Turn tile 126 returns a credit return message ‘CRV’ to source agent tile 102 along a vertical forwarding path 306. Separately, in response to receiving transaction message 300 from Turn tile 126, destination agent tile 130 returns a credit return message ‘CRH’ to Turn tile 126 along a horizontal forwarding path 308. As with end-to-end crediting, credit returns for multiple messages may be combined to reduce traffic.

As used herein, the portion of a forwarding path for which credits are implemented is called a “credit loop.” As further depicted in FIG. 3 by the dotted outlines, the forwarding of the transaction message via vertical path 302 and credit return via vertical path 306 constitutes a first credit loop ‘1’ (indicated by the encircle ‘1’) between source agent tile 102 and Turn tile 126, while the forwarding of the transaction message via horizontal path 304 and credit return via horizontal path 308 constitutes a second credit loop ‘2’ between Turn tile 126 and destination agent tile 130. In the context of the credit loops herein, messages are forwarded from a sender to a receiver, and credit returns are sent from the receiver back to the sender. In order to forward a message from a sender to a receiver for a give credit loop, the sender must have adequate credit to send to the receiver, similar to source needed adequate credit to send to a destination under end-to-end crediting.

In addition to forwarding via a first vertical path segment followed by a second horizontal path segment, the first path segment may be horizontal and the second path segment vertical, as shown in FIG. 3a. In this example, a transaction message 310 originating from source agent tile 102 is forwarded along a first segment comprising a horizontal forwarding path 312 to tile 106, which is implemented as a Turn tile. Transaction message 310 is then forwarded along a second segment comprising a vertical forwarding path 314 from Turn tile 106 to destination agent tile 130.

In the embodiment illustrated in FIG. 3a, in response to receiving transaction message 310, Turn tile 106 returns a credit return message ‘CRH’ message along a horizontal forwarding path 316 to source agent tile 102. Separately, in response to receiving transaction message 310, destination agent tile 130 returns a credit return message ‘CRV’ that is forwarded along a vertical forwarding path 318 to Turn tile 106. Accordingly, in FIG. 3a, there is a first credit loop between source agent tile 102 and Turn tile 106, and a second credit loop between Turn tile 106 and destination agent tile 130.

Under the scheme illustrated in FIG. 3, to facilitate forwarding of messages that are received from a source agent to a destination agent, a Turn tile in the same column as the source agent tile only needs to manage credits for the tiles in its row (or, in the case tiles are implemented on multiple dies, only the tiles in its row on the same die). Similarly, under the scheme illustrated in FIG. 3a, to facilitate forwarding of messages that are received from a source agent to a destination agent, a Turn tile in the same row as the source agent tile only needs to manage credits for the tiles in its column (or, in the case tiles are implemented on multiple dies, only the tiles in its column on the same die).

Under multi-level crediting, the management of credits on source agent tiles is also reduced. Rather than having to manage credits for all tiles in a different row or column than the source agent tile that could be potential destinations for transactions originating from a source agent tile, the source agent only needs to manage credits for forwarding messages to tiles in the same column (for vertical first forwarding path segments) or row (for horizontal first forwarding path segments) as the source agent tile. It may also be possible to remove the Link Layer credits in some embodiments, depending on the underlying microarchitecture.

Under various embodiments, one or more different types of buffers and associated credit mechanisms may be implemented a Turn tiles and source agents. For example, one type of buffer is called a transgress buffer (TGR), which is implemented at each mesh stop node (i.e., Turn tile) that buffer messages that need to turn from V to H. Turn-agent (TA) ingress buffers are implemented at mesh stops to buffer messages that are turned from H to V. In some embodiments, the two-dimensional (2D) mesh of tiles is implemented using multiple interconnected dies. Common Mesh Stop (CMS) ingress buffers are implemented at mesh stops at die crossings.

Conceptually, the TGRs, TA ingress buffers, and CMS ingress buffers are implemented in place of destination ingress buffers at the turn tile for the first segment of the forwarding path, or in the case of CMS, at a tile at a die crossing for forwarding paths that cross dies in a multi-die topology. For example, if the first segment is a vertical path segment, a TGR is used as the ingress buffer for that segment. If the first segment is a horizontal path segment, a TA ingress buffer is used as the ingress buffer for that segment. A given tile may implement one or more of TGRs, TA ingress, and CMS ingress buffers, depending on the particular implementation and mesh topology. For embodiments where the mesh interconnect is implemented on a single die, CMS-related components, such as CMS ingress buffers, will not be used.

Each TGR/TA/CMS/Destination needs a credit pool per source that can target it. In one embodiment, this/these credit pool(s) is/are shared across message types. This first type of credit pool is referred to herein as a ‘VNA’ credit pool. In some embodiments, extra entries are introduced per independent message class in each physical channel's transgress buffer to provide deadlock-free routing. This is referred to herein as the VN0 credit pool. In one embodiment, one entry in each transgress ingress is assigned to each message class and is shared amongst messages to all destinations. In one embodiment, transgress VN0 buffers are shared amongst agents in the same column sourcing messages to a particular row via a vertical VN0 credit ring.

Credited messages are implemented in the following manner for the first forwarding path segments. Source Agents pushing messages destined for destination agents acquire a VNA or VN0 credit, corresponding to TGR, TA ingress buffer or CMS ingress buffer, as applicable, instead of the destination ingress buffer of the destination agent tile. Generally, this is similar to current practices for credited message flows, except the credits are managed and tracked at a Turn tile or CMS tile rather than at the destination agent tile. In one embodiment, independent traffic flows requiring concurrent bandwidth use separate VNA pools to guarantee QoS (Quality of Service) performance. If certain message types are low bandwidth, they can be lumped together into a separate end-to-end message class, as well.

The multi-level crediting scheme also simplifies management of credited messages at the destination. From the perspective of a destination agent, the only senders of messages are the tiles implemented as Turn tiles in the same row (for vertical first path segments) or column (for horizontal first path segments) as the destination agent, and on the same die. Presuming a Turn tile is implemented for each column, the destination only needs to size credits to cover the number of columns on its own die.

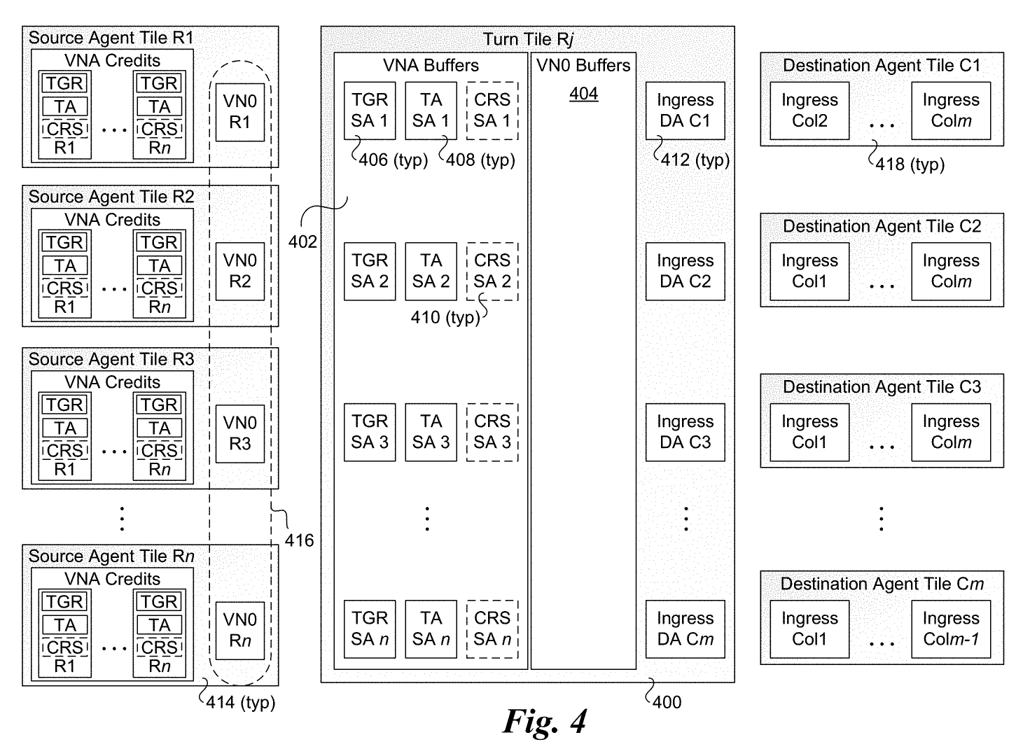

FIG. 4 shows selected aspects of an implementation of multi-level crediting from the perspectives of source agent tiles for a given column, a single Turn tile, and destination agent tiles for a single row. The diagram corresponds to a mesh fabric for a tile configuration of n rows and m columns, where n and m are integers. For illustrative purposes the source agent tiles for a single column are shown, a single Turn tile is shown for that same column, and destination agent tiles are shown for the same row as the Turn tile.

In further detail, a Turn tile 400 (also labeled Rj to indicate the Turn tile is the j^{th} row) includes a VNA buffer pool 402, and a VN0 buffer pool 404. The VNA buffer pool includes a buffer allocation for a TGR 406, and TA ingress buffer 408, for each source agent in the same column as the Turn tile. Optionally, VNA buffer pool 402 may include one or more CMS ingress buffers 410). As further shown, the sets of buffers are labeled, ‘SA 1,’ ‘SA 2,’ ‘SA 3,’ . . . ‘SA n,’ where ‘SA’ stands for Source Agent, and the number corresponds to the row of the source agent. Similar sets of buffers may be allocated for VN0 buffer pool 404 (not shown). Turn tile 400 also depicts an ingress credit 412 for each destination agent tile, labeled Ingress DA C1, Ingress DA C1, Ingress DA C1, . . . Ingress DA Cm, where ‘DA’ stand for Destination Agent, ‘C’ stands for Column, and the number identifies the column number.

Each of source agent tiles 414 are labeled Source Agent Tile R1, R2, . . . Rj, . . . Rn, where the number represents the row number of the source agent tile. As mentioned above, the source agent tiles are in the same column as the Turn tile; for simplicity presume that the column is the first column, while it shall be recognized that a similar configuration would be used for each of the m columns. Each source agent tile will include a pool of VNA credits, with a set of one or more of TGR and TA credits for each of n rows, noting a source agent tile will not have any VNA credit information for sending messages to itself. CMS credits may also be included for implementations that use multiple dies, wherein CMS credits are managed for forwarding messages via CMS tiles.

As discussed above, for credited messages it is necessary for a given source agent to have enough credits for an ingress buffer at the destination before the source agent can send the message (i.e., insert the message onto a ring, which would be a column-wise ring in the example of FIG. 4). In the embodiments herein, those credits are in the VNA and VN0 credit pools, and the ingress buffers for which credits are needed are the TGR/TA/CMS ingress buffers for the Turn tile via which the message will be forward. For example, if Source Agent Tile R1 desires to send a message to any destination agent tile in the same row as Turn tile 400 and the first forwarding path segment is vertical, then Source Agent Tile R1 would need enough credits in its TGR credits for the j^{th} row, and the VNA buffer that would receive the message would be TGR SA 1. If the first forwarding path segment is horizontal and the destination agent tile was in the k^{th} column, then Source Agent Tile R1 would need enough credits in its TA credits for the first row, and the VNA buffer that would receive the message would be a TA SA 1 buffer (not shown, since the Turn tile would be in row 1 rather than row j.

VN0 credits are handled differently. As discussed above, in one embodiment, transgress VN0 buffers are shared amongst agents in the same column sourcing messages to a particular row via a vertical VN0 credit ring. This is depicted in FIG. 4 as a vertical VN0 credit ring 416. In one embodiment, the VN0 credit ring carries 1 credit per message class that can be acquired by any source that is attached to the ring (for any destination on that dimension). Sources may implement mechanisms to detect starvation for a particular message class that triggers logic to acquire a VN0 credit from the VN0 credit ring. Sources may also opportunistically bid for a VN0 credit, and immediately return the credit back to the ring if a VNA credit became available. Once a VN0 credit is acquired and used for a transaction, source must indicate on the outgoing transaction that a VN0 credit was used. This allows the destination to return a VN0 credit back to the source via a credit return packet. Upon receiving the credit return packet, the source must return the VN0 credit back to the VN0 credit ring. It should not use it immediately for another transaction. This ensures that all potential sources on the VN0 credit ring get a fair chance at using VN0 credits—allowing the overall system to be deadlock free. Several other mechanisms of ensuring fairness with VN0 may be employed with different trade-offs (1 VN0 credit per destination per message class, time-multiplexed slots dedicated for VN0 traffic etc.)

The second half of the forwarding path is the from the Turn tile to the destination agent tile. In the example of FIG. 4, this is a horizontal forwarding path from a Turn tile in the first column to a destination agent tile an of columns 2 through m. In FIG. 4, there are four destination agent tiles 418 labeled Destination Agent Tile C1, C2, C3, . . . Cm, wherein ‘C’ represents Column followed by the column number. Each of destination agent tiles 418 includes an ingress buffer form−1 columns, wherein there is no ingress buffer for the same column occupied by a given destination agent tile. As discussed above, this simplifies handling credited messages at the destination agent tiles, since credits only need to be managed for receiving messages forwarded from the Turn tiles in the same row and on the same die as the destination agent tile.

In the foregoing examples, the overall end-to-end forwarding path is broken into two credit loops. However, the concept of multi-level crediting may be extended to more than two credit loops, such as using three or more forwarding path segments (and associated credit loops). It also may be extended across dies boundaries uses CMS nodes.

An example of forwarding a transaction message and associated credit loops using multi-level crediting for an architecture employing multiple interconnected dies and employing three forwarding path segments is illustrated in FIG. 3b. Architecture 320 includes two Dies ‘1’ and ‘2’, each having multiple tiles configured in a 2D array of rows and columns interconnected via a mesh fabric, with further interconnections between tiles on adjacent sides of a die boundary 321. The tile and mesh interconnect configuration for Die 1 is the same as for architecture 100 shown in FIGS. 3a and 3b and discussed above, except that tile 130 is now labeled as a stage tile rather than a destination agent tile. In one embodiment, Die 2 has a similar configuration (noting that only a portion of Die 2's tiles are shown due to space limitations), depicted as tiles 322, 324, 326, 328, 330, 332, 334, and 336. However, the use of dies with similar configurations is merely one example, as interconnected dies may have different configurations, as well. For example, a first die might comprise a CPU having a number of processor cores, while a second die might be a GPU (graphics processing unit), which has a substantially different configuration than a CPU. These are merely two examples that are non-limiting.

Under architecture 300 the tiles 108, 116, 124, 132, 322, 236, 330, and 334 along the vertical edges of Die 1 and Die 2 that are adjacent to die boundary 321 are labeled ‘CMS,’ identifying these tiles as common mesh stop tiles. As further shown, there are bi-directional horizontal interconnects (shown in black) between pairs of adjacent CMS tiles (e.g., between tiles 108 and 322). In other embodiments, there may not be interconnects between adjacent tiles along a common inter-die boundary. Accordingly, those tiles may not be CMS tiles. It if further noted that the CMS functionality and the functionality of a Turn tile may be implemented on the same tile, in some embodiments.

In the example illustrated in FIG. 3b, a transaction message 338 is forwarded from source agent tile 102 on Die 1 to tile 336 on Die 2, which is the destination agent tile. The forwarding path traverses, in sequence, stage tiles 110 and 118, Turn tile 126, stage tiles 128 and 130, CMS tiles 132 and 334, and ends at destination tile 336. As further depicted, the forwarding path is partitioned into a first vertical path segment 340, a second horizontal path segment 342, and a third horizontal path segment 344, each of which has an associated credit loop ‘1’, ‘2’, and ‘3’, respectively.

Credit loop ‘1’ is between source agent tile 102 and Turn tile 126. Credit loop ‘2’ is between Turn tile 126 and CMS tile 132, while credit loop ‘3’ is between CMS tile 132 and destination agent tile 336. In credit loop ‘1’, a credit CRV is returned from Turn tile 126 to source agent tile 102 via a credit return path 346. In credit loop ‘2’, a credit CRH1 is returned from CMS tile 132 to Turn tile 126 via a credit return path 348. In credit loop ‘3’, a credit CRH2 is returned from destination agent tile 336 to CMS tile 132 via a credit return path 350.

In some CMS embodiments, common mesh stops are no longer required to acquire transgress credits for messages on the vertical ring. Transgress credits are returned to the agent and used as a protocol credit. Also, agents no longer receive a dedicated allocation per destination port, and Link Layer credits may be eliminated.

In addition to the two-die configuration shown in FIG. 3b, other multi-die configurations may be implemented, including but not limited to a 2D array of dies (e.g., 4 dies, 6 dies, 8 dies, etc.), a single column of two or more dies, or a single row of two or more dies. In the foregoing examples, the multiple dies are on the same substrate. However, this too is not limiting, as multiple interconnected dies may also be implemented on separate substrates or packages, such as used in multi-chip modules.

Buffered Mesh

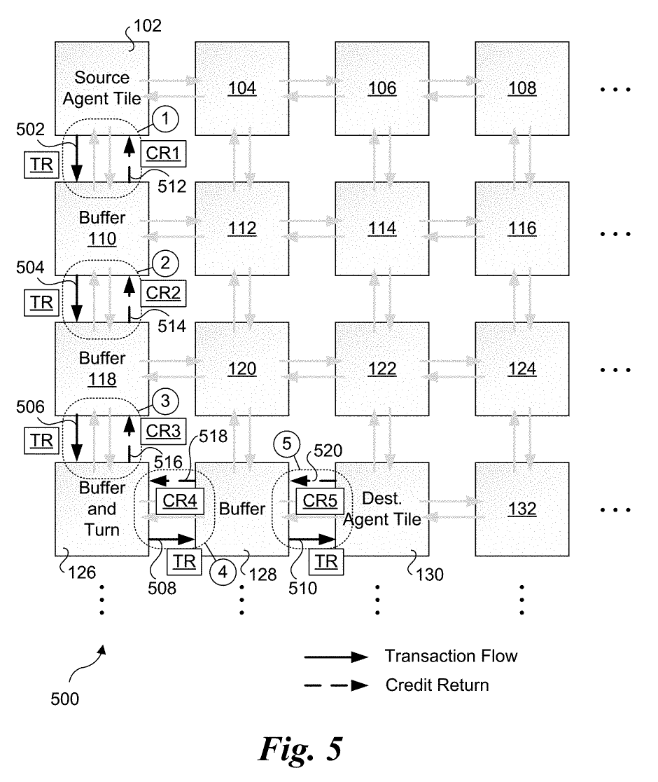

Under an approach called “buffered mesh,” Protocol Layer credits are tracked on a hop-to-hop basis, with no Link Layer credits required, with the credit loops being between adjacent tiles (or adjacent mesh stops or node stops for other interconnect topologies). An example of forwarding a transaction message TR from source agent tile 102 to destination agent tile 130 using buffered mesh is shown in FIG. 5. As with FIGS. 2 and 3, the forwarding path is vertical between source agent tile 102 and tile 126, and horizonal from tile 126 to destination agent tile 130. Tile 126 is also referred to as a Buffer and Turn tile in this embodiment.

As shown in FIG. 5, the overall forwarding path of transaction message TR is partitioned into a succession of “hops” between adjacent tiles. In the forwarding path, these hops are associated with link segments 502, 504, 506, 508, and 510. Tiles along intermediate portions of the overall forwarding path are labeled as Buffer tiles (e.g., Buffer tiles 110, 118 and 128), with the except of the tile at the turn, which is labeled Buffer and Turn tile 126, as discussed above.

Under buffered mesh, credits are implemented individually for each hop, as depicted by credit return messages ‘CR1’, ‘CR2’, ‘CR3’, ‘CR4’ and ‘CR5’, which are respectively forwarded along link segments 512, 514, 516, 518, and 520, with each link segment coupled between adjacent tiles. This approach eliminates the need for credit return rings, and instead uses the individual link segments, using one set of wires per message class for credit returns, in one embodiment.

As further shown, in this example there are five credit loops ‘1’, ‘2’, ‘3’, ‘4’, and ‘5’, wherein each credit loop is between adjacent tiles along the forwarding path. Under buffered mesh, a forwarding path that includes hops between j tiles (or node) will have j−1 credit loops.

Crediting may be done using various schemes. For example, under a first scheme, dedicated buffers are provided per message class. Under a second scheme, a shared pool of credits is used for performance, and a few dedicated per-message class buffers are used for QoS and deadlock avoidance. Variations on these two schemes may also be implemented.

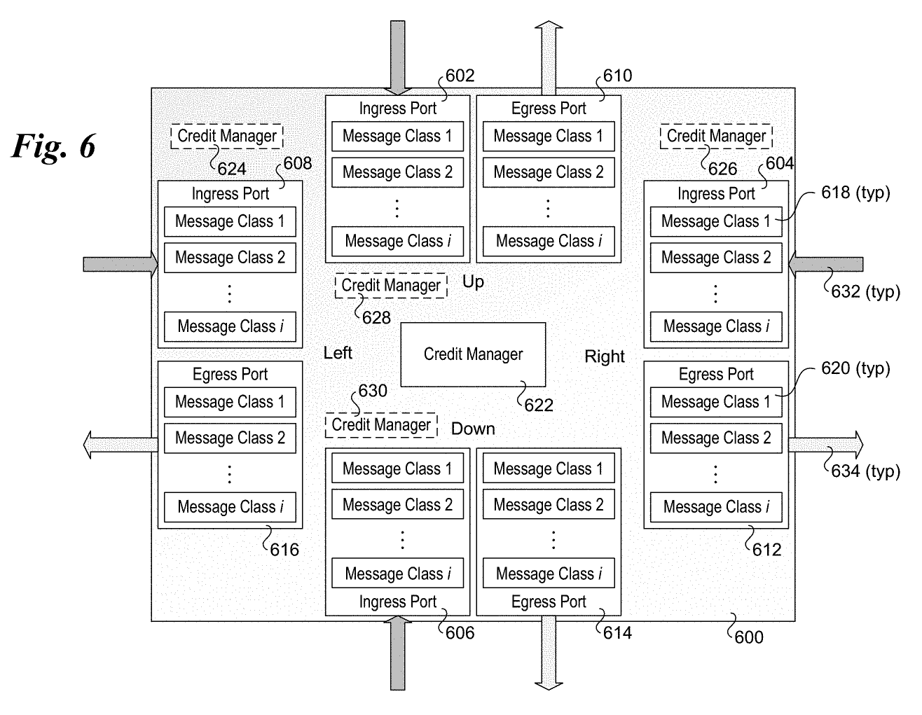

FIG. 6 shows an example of a mesh stop 600 for an interior tile that implements dedicated buffers per message class. As shown, there is an ingress port and egress port pair for each of directions Vertical-Up, Vertical-Down, Horizontal-Left and Horizontal-Right, including ingress ports 602, 604, 606, and 608, and egress ports 610, 612, 614, and 616. Each ingress port includes ingress buffers 618 for i messages classes, where i is an integer. Similarly, each egress port includes egress buffers 620 for i messages classes. Generally, an ingress or egress message class buffer may be implemented in any of a variety of known manners, such as a FIFO (first-in, first-out) buffer or memory region in the ingress or egress port allocated for a given message class. A combined approach may also be used, such as storing message pointers in a FIFO that point to message data stored in a memory region allocated for a particular class or a shared class memory pool. This approach may be advantageous for variable-size messages, for example. The FIFOs may be implemented as circular FIFOs in some embodiments.

In addition to ingress and egress buffers, each mesh stop will include a means for managing credits. In one embodiment, a central credit manager 622 is used, which manages credits (e.g., keeping per-class credit counts and generating credit returns) for each of the four directions. Alternatively, a separate credit manager may be used for each direction, as depicted by credit managers 624, 626, 628, and 630.

For illustrative purposes, only single arrows 632 and 634 (representative of a physical channel) are shown going into the ingress ports and out of the egress ports. This corresponds to implementations where multiple classes share a physical channel. For implementations where messages from different classes are sent over separate sets of wires (separate physical channels), there would be an ingress port and egress port for each physical channel, and the ingress and egress buffers would be for a single message class.

For implementations under which multiple message classes share a physical channel, an arbitration mechanism will be implemented the egress of messages (not shown). Various arbitration schemes may be used, and different priority levels may be implemented under such arbitration schemes. Further aspects of credit arbitration are described below.

Under one embodiment, each mesh stop has a separate logic buffer per-direction, per-dimension. This results in four logical buffers in the 2D mesh topology—Vertical-Up, Vertical-Down, Horizontal-Left, and Horizontal-Right. Logic buffers are employed for storage for transactions to allow routing/credit allocation decisions to be made. In some embodiments, logic buffers may be physically combined to fewer storage units for efficiency.

Once a transaction is in a logic buffer, there are three options:
Sink the transaction into the current mesh stop agent;
Move the transaction forward along the same path that it came from—as an example if it was traveling from left to right, it will check credits for the next mesh stop to the right and schedule itself on the ring for transfer; or
Make a turn from a vertical ring to a horizontal ring or from a horizontal ring to a vertical ring.

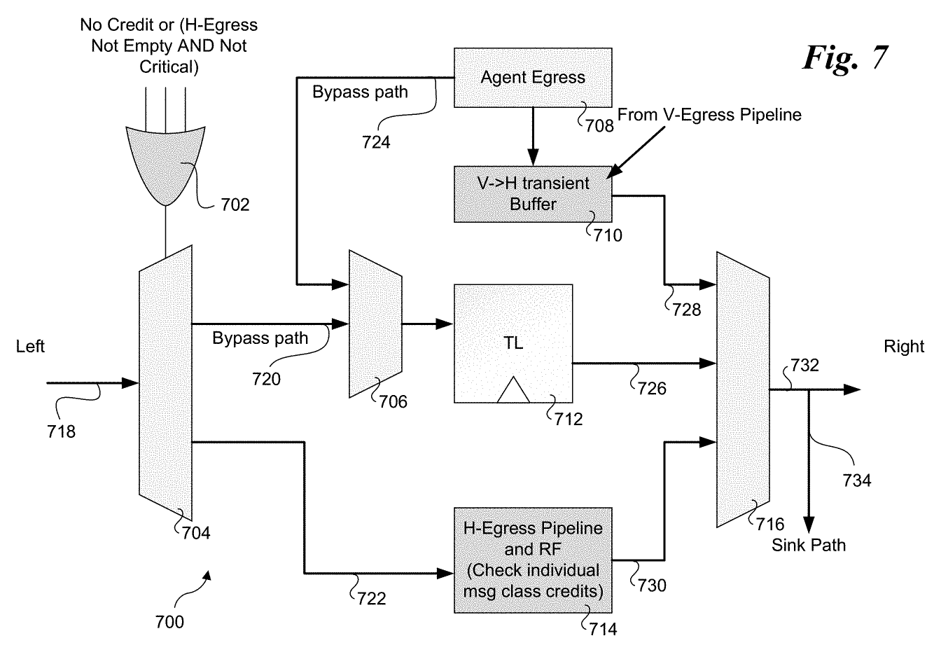

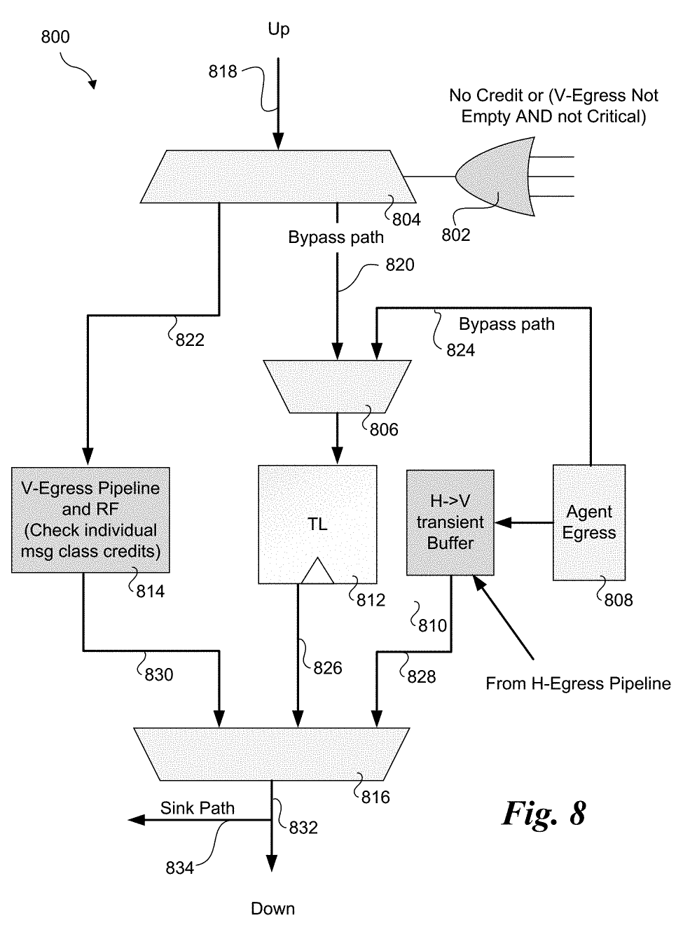

As illustrated below in FIGS. 7 and 8, if credits to all message classes are available and there also is a slot for transfer, there is a provision to take a bypass path and avoid sinking into the logic buffer. This helps reduce idle latency.

For mesh stops in the interior of a 2D mesh topology, each mesh stop maintains four independent sets of credit counters corresponding to the four neighbors it can target (two directions on vertical, two directions on horizontal). For mesh stops along the outer edge of the 2D mesh topology, three independent sets of credit counter are maintained respectively corresponding to the three neighbors the mesh stops can target (two vertical, one horizontal for mesh stop along the left or right edge, one vertical, two horizontal for mesh stops along the top or bottom edge). For mesh stops at the outer corners of the 2D mesh topology, two independent sets of credit counters are maintained (one vertical, one or horizontal. In addition, the mesh stop maintains an agent egress buffer, along with a credit counter to check credits for agent ingress (for sinking traffic).

In one embodiment, a co-located agent egress can inject in all four directions for internal mesh stops, in three directions for non-corner outer edge mesh stops, and in two directions for outer corner mesh stops. The co-located agent egress arbitrates for credits from the egress queue. Once a credit is acquired, it will wait in a transient buffer to be scheduled on the appropriate direction.

Sinking to a co-located agent can be done from all directions, or a subset of directions (e.g., Horizontal or Vertical only), depending on performance and implementation considerations. If agent ingress credits are available, the agent ingress can bypass the logic buffer and sink directly, thereby saving latency.

In one embodiment, three separate entities can be arbitrating for credit concurrently. As an example, consider the credit counter for the mesh stop to the right of current stop on a horizontal ring. The entities that can concurrently arbitrate for credit include,
1) The H-egress pipeline used for traffic going from left to right
2) Agent egress traffic that wants to schedule on the horizontal right direction
3) V-egress pipeline for traffic that wants to turn from Vertical to Horizontal direction

Once a credit is acquired, the corresponding transaction is guaranteed a slot to make it to the corresponding destination. As a result, no special anti-deadlock slots or anti-starvation schemes are required, other than fairness for credit allocation.

Several QoS schemes are possible for critical traffic that is latency sensitive. For example, in one embodiment, critical traffic is given priority for bypass and credit arbitration. In addition, in one embodiment sink/turn computation may be done one stop before (the current mesh stop) to help with physical design timing.

The buffered mesh approach provides a way to eliminate bouncing, anti-deadlock slots and anti-starvation mechanisms that are associated with conventional implementations. This may be obtained using a certain number of buffers to maintain performance between hops, and the algorithm for credit acquirement can be used to adjust performance and QoS without penalizing the source or destination agents. In some embodiments, bouncing is proposed primarily to avoid dedicated buffers at destination per source and the fallout of enabling bouncing is the need for anti-deadlock and anti-starvation schemes.

FIG. 7 shows a high-level logic diagram 700 for a single horizontal direction (left->right) data path for a mesh stop, according to one embodiment. Logic elements in logic diagram 700 include a complex OR/AND logic gate 702, a demultiplexer (demux) 704, a multiplexer (mux) 706, and agent egress 708, Vertical to Horizontal (V->H) transient buffer 710, a transparent latch (TL) 712, a Horizontal egress (H-Egress) pipeline and Register File (RF) 714, and a mux 716.

An input message 718 is received from an adjacent tile to the left (not shown) as an input to demux 704. Complex OR/AND logic gate 702 has three inputs—No Credit OR (H-Egress Not Empty AND not Critical). The output of complex OR/AND logic gate 702 is used as a control input to demux 704. If the output of complex OR/AND logic gate 702 is TRUE (logical ‘1’), the input message is forwarded along a bypass path 720, which is received as an input by mux 706. If the output of complex OR/AND logic gate 702 is FALSE (logical ‘0’), message 718 is forwarded via a path 722 to H-Egress pipeline and RF 714. Agent Egress 708 outputs a message along a bypass path 724, which is a second input to mux 706. The output of mux 706 is gated by transparent latch 712, whose output 726 is the middle input to mux 716. The other two inputs for mux 716 are an output 728 from V->H transient buffer 710 and an output 730 from H-Egress pipeline and RF 714. As further shown, V->H transient buffer 710 receives an input from the V-Egress Pipeline.

The output 732 of mux 716 will depend the various inputs to the logic in view of the messages in the V-Egress Pipeline and H-Egress Pipelines. For example, in accordance with a left-to-right Horizontal forwarding operation, message 718 may be forwarded as output 732 to an adjacent tile on the right (not shown). If there are messages in the V-Egress Pipeline, then, during a given cycle, one of those messages may be forwarded as output 732, thus effecting a V->H turning operation. If the destination for input message 718 is the tile on which the logic in logic diagram 700 is implemented, then when the input message is output by mux 716, it will follow a sink path 734.

FIG. 8 shows a high-level logic diagram 800 for a single vertical direction (up->down) data path for a mesh stop, according to one embodiment. Logic elements in logic diagram 800 include a complex OR/AND logic gate 802, a demux 804, a mux 806, and agent egress 808, Horizontal-to-Vertical (H->V) transient buffer 810, a transparent latch (TL) 812, a Vertical egress (V-Egress) pipeline and RF 814, and a mux 816.

The operation of the logic in logic diagram 800 is similar to the operation of the logic in logic diagram 700 discussed above. An input message 818 is received from an adjacent tile to the left (not shown) as an input to demux 804. Complex OR/AND logic gate 802 has three inputs—No Credit OR (H-Egress Not Empty AND not Critical). The output of complex OR/AND logic gate 802 is used as a control input to demux 804. If the output of complex OR/AND logic gate 802 is TRUE (logical ‘1’), the input message is forwarded along a bypass path 820, which is received as an input by mux 806. If the output of complex OR/AND logic gate 802 is FALSE (logical ‘0’), message 818 is forwarded via a path 822 to V-Egress pipeline and RF 814. Agent Egress 808 outputs a message along a bypass path 824, which is a second input to mux 806. As before, the output of mux 806 is gated by transparent latch 812, whose output 826 is the middle input to mux 816. The other two inputs for mux 816 are an output 828 from H->V transient buffer 810 and an output 830 from V-Egress pipeline and RF 814. As further shown, H->V transient buffer 810 receives an input from the H-Egress Pipeline.

The output 832 of mux 816 will depend the various inputs to the logic in view of the messages in the H-Egress Pipeline and V-Egress Pipeline. For example, in accordance with an up-to-down Vertical forwarding operation, message 818 may be forwarded as output 832 to an adjacent tile on the right (not shown). If there are messages in the V-Egress Pipeline, then, during a given cycle, one of those messages may be forwarded as output 832, thus effecting a V->H turning operation. If the destination for input message 818 is the tile on which the logic in logic diagram 800 is implemented, then when the input message is output by mux 816, it will follow a sink path 834.

As will be recognized by those skilled in the art, logic for implementing a right-to-left Horizontal data path and a down-to-up Vertical data path would have similar configurations to the logic shown in FIGS. 7 and 8. For an interior (to the tile topology) mesh stop, logic for implementing data paths in all four directions will be implemented. For tiles in an outside row or column that are not at the corners, three directions will be implemented, and for out tiles at the corners, two directions will be implemented.

Source Throttling

Source throttling is a concept that is similar for both multi-level crediting and buffered mesh. Generally, in a mesh architecture, not all the source or destination agents source or sink traffic at the same rate. Accordingly, in some embodiments, measures are taken for preventing slower agents from flooding the fabric and preventing the faster agents from getting their desired bandwidth. Source throttling follows the “good citizen” principle to cap the maximum bandwidth that a particular message type from a source can take before back-pressuring itself.

Under one embodiment, each source maintains a counter for each possible destination. The counter is incremented when a request is sent to that destination and decremented when either a response comes back or a fixed time window has passed (the time window can be tuned to give optimal performance). Thus, this counter is tracking the number of outstanding requests to a particular destination. If the destination is fast, and returning responses quickly, the counter remains at a low value. If the destination is slow, the counter gets a larger value, and requests can be blocked through a programmable threshold. This gives a cap on the number of outstanding transactions to a destination from a source and limits flooding of the fabric with slow progressing transactions.

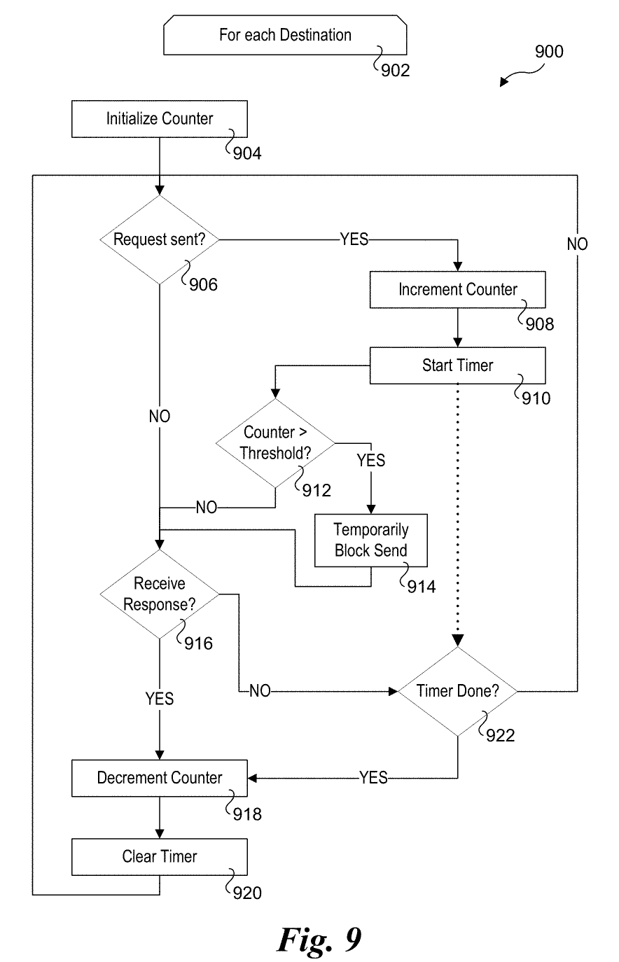

FIG. 9 shows a flowchart 900 illustrating operations and logic for implementing source throttling, in accordance with one embodiment. As show at the top of the flowchart in a block 902, the operations and logic are implemented for each destination the source can target. In a block 904, the counter is initialized. Generally, the counter will be initialized to some predetermined count, such as zero. Following initialization of the counter, the remaining operations and logic are performed in a loop-wise manner in an ongoing basis.

In a decision block 906 a determination is made whether a request has been sent. In connection with sending a request for the source, the answer to decision block 906 will be YES, and the logic will proceed to a block 908 in which the counter is incremented. A timer will then be started in a block 910 with a predetermined value corresponding to the fixed time window discussed above.

Next, in a decision block 912 a determination is made to whether the current counter value has exceeded a programmable threshold. If YES, then the logic proceeds to a block 914 in which the source is temporarily blocked from sending additional requests. Generally, the amount of time the source is blocked is tunable, based on one or more of real-time observations or observations made during previous testing.

If the answer to either decision block 906 or decision block 912 is NO, or if the path through block 914 is taken, the logic proceeds to a decision block 916 in which a determination is made to whether a response has been received. If YES, the logic proceeds to a block 918 in which the counter is decremented. The timer is then cleared in a block 920, and the logic loops back to decision block 906 and the process is repeated.

As discussed above, the counter may also be decremented if a fixed time window has passed. This is depicted by a decision block 922, in which a determined is made to whether the timer is done (i.e., the time window has expired). If so, the answer is YES and the logic proceeds to block 918 in which the counter is decremented. If the time window has not passed, the answer to decision block 922 is NO, and the logic loops back to decision block 906.

As will be recognized by those skilled in the art, the decision block operations shown in flowchart 900 are merely for illustrative purposes and generally would be implemented in an asynchronous manner, rather than as sequence of logic operations. For example, separate provisions could be implemented in egress and ingress ports to increment and decrement a counter and for implementing the timer.

Exemplary Computer System Implementing Mesh Interconnect

FIG. 10 shows a computer system 10 that includes a SoC processor 1002 implementing a mesh interconnect architecture. SoC 1002 includes 30 tiles 1004 arranged in five rows and six columns. Each tile 1004 includes a respective mesh stop 1006, with the mesh stops interconnected in each row by a ring interconnect 1008 and in each column by a ring interconnect 1010. Ring interconnects 1008 and 1010 may be implemented as uni-directional rings (as shown) or bi-directional rings.

Processor SoC 1002 includes 22 cores 1012, each implemented on a respective tile 1004 and co-located with an L1 and L2 cache, as depicted by caches 1014 for simplicity. Processor SoC 1002 further includes a pair of memory controllers 1016 and 1018, each connected to one of more DIMMs (Dual In-line Memory Modules) 1020 via one or more memory channels 1022. Generally, DIMMs may be any current or future type of DIMM such as DDR4 (double data rate, fourth generation). Alternatively, or in addition to, NVDIMMs (Non-volatile DIMMs) may be used, such as but not limited to Intel® 3D-Xpoint® NVDIMMs.

Processor SoC 1002 further includes a pair of inter-socket links 1024 and 1026, and four Input-Output (IO) tiles 1028, 1030, 1032, and 1034. Generally, IO tiles are representative of various types of a components that are implemented on SoCs, such as Peripheral Component Interconnect (PCIe) IO components, storage device IO controller (e.g., SATA, PCIe), high-speed interfaces such as DMI (Direct Media Interface), Low Pin-Count (LPC) interfaces, Serial Peripheral Interface (SPI), etc. Generally, a PCIe IO tile may include a PCIe root complex and one or more PCIe root ports. The IO tiles may also be configured to support an IO hierarchy (such as but not limited to PCIe), in some embodiments.

As further illustrated in FIG. 10, IO tile 1028 is connected to a firmware storage device 1036 via an LPC link, while IO tile 1030 is connected to a non-volatile storage device 1038 such as a Solid-State Drive (SSD), or a magnetic or optical disk via a SATA link. Additionally, IO interface 1034 is connected to a Network Interface Controller (NIC) 1040 via a PCIe link, which provides an interface to an external network 1042.

Inter-socket links 1024 and 1026 are used to provide high-speed serial interfaces with other SoC processors (not shown) when computer system 1000 is a multi-socket platform. In one embodiment, inter-socket links 1024 and 1026 implement Universal Path Interconnect (UPI) interfaces and SoC processor 1002 is connected to one or more other sockets via UPI socket-to-socket interconnects.

It will be understood by those having skill in the processor arts that the configuration of SoC processor 1002 is simplified for illustrative purposes. A SoC processor may include additional components that are not illustrated, such as one or more last level cache (LLC) tiles, as well as components relating to power management, and manageability, just to name a few. In addition, only a small number of tiles are illustrated in SoC processor 1002. The teaching and principles disclosed herein support implementations having larger scales, such as 100's or even 1000's of tiles and associated mesh stops.

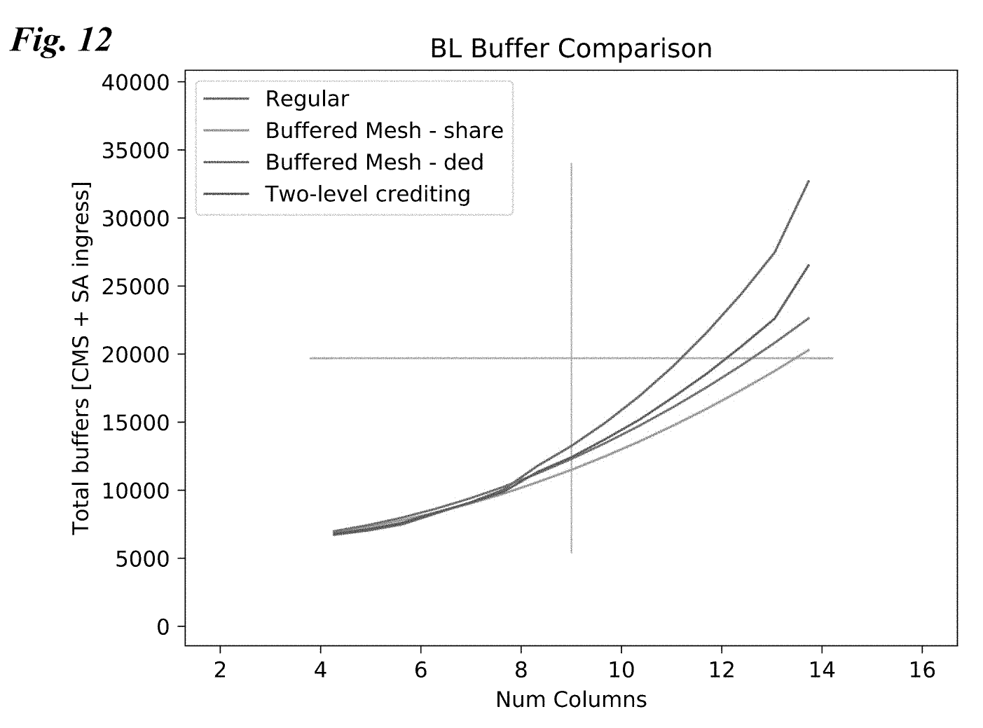

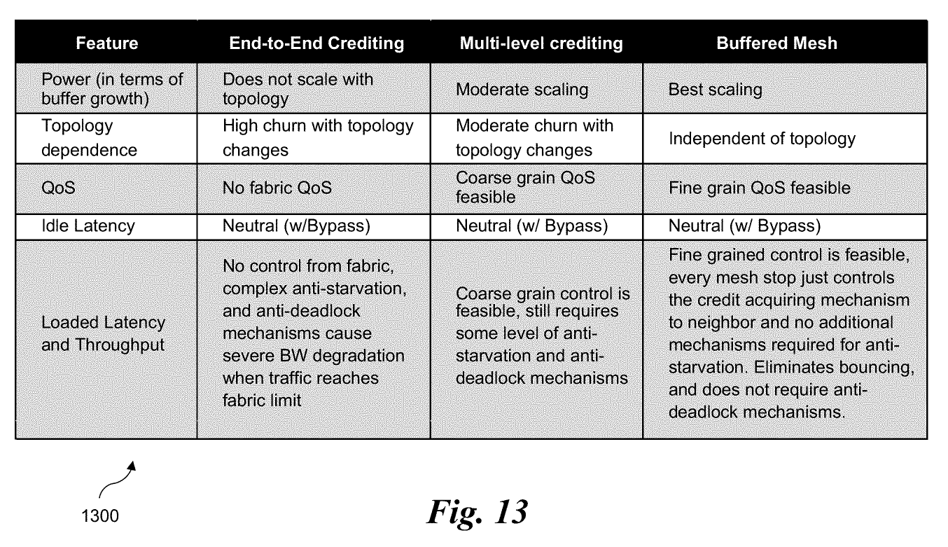

Generally, SoC processor 1002 may implement one or more of multi-level crediting, mesh buffering, and end-to-end crediting. For example, credit loops ‘1’ and ‘2’ correspond to an example of multi-level crediting, which credit loop ‘3’ depicts an example of a credit loop for mesh buffering. In some embodiments, it may be advantageous to implement mesh buffering for a portion (or portions) of the interconnect topology, while implementing multi-level crediting or end-to-end crediting for one or more other portions of the topology. In other embodiments, mesh buffering may be implemented for the entire interconnect topology. Further details regarding using a combination of these approaches for credited messages are describe below with reference to FIGS. 12 and 13.

Exemplary Multi-Socketed Computer System Implementing Ring Interconnects

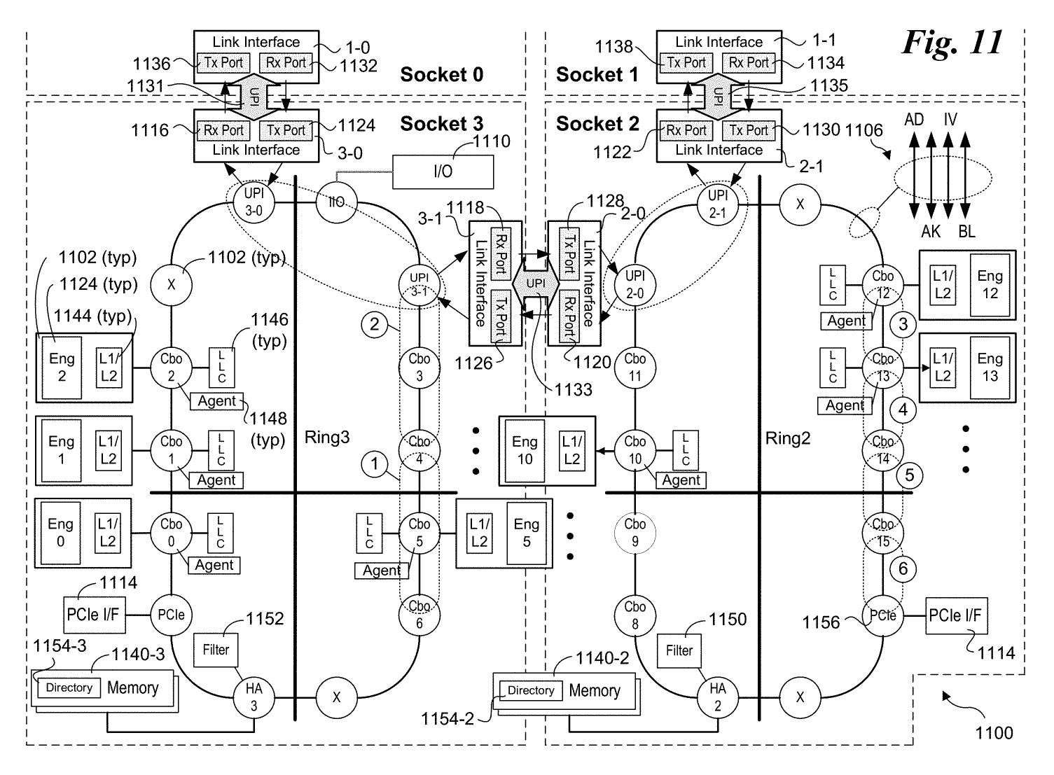

System 1100 of FIG. 11 shows an example of a multi-socketed computer system implementing ring interconnects that may be configured to practice aspects of the embodiments disclosed herein. System 1100 employs SoC processors (CPU's) supporting multiple processor cores 1102, each coupled to a respective node 1104 on a ring interconnect, labeled and referred to herein as Ring2 and Ring3 (corresponding to CPU's installed in CPU sockets 2 and 3, respectfully). For simplicity, the nodes for each of the Ring3 and Ring2 interconnects are shown being connected with a single line. As shown in detail 1106, in one embodiment each of these ring interconnects include four separate sets of “wires” or electronic paths connecting each node, thus forming four rings for each of Ring2 and Ring3. In actual practice, there are multiple physical electronic paths corresponding to each wire that is illustrated. It will be understood by those skilled in the art that the use of a single line to show connections herein is for simplicity and clarity, as each particular connection may employ one or more electronic paths.

In the context of system 1100, a cache coherency scheme may be implemented by using independent message classes. Under one embodiment of a ring interconnect architecture, independent message classes may be implemented by employing respective wires for each message class. For example, in the aforementioned embodiment, each of Ring2 and Ring3 include four ring paths or wires, labeled and referred to herein as AD, AK, IV, and BL. Accordingly, since the messages are sent over separate physical interconnect paths, they are independent of one another from a transmission point of view.

In one embodiment, data is passed between nodes in a cyclical manner. For example, for each real or logical clock cycle (which may span one or more actual real clock cycles), data is advanced from one node to an adjacent node in the ring. In one embodiment, various signals and data may travel in both a clockwise and counterclockwise direction around the ring. In general, the nodes in Ring2 and Ring 3 may comprise buffered or unbuffered nodes. In one embodiment, at least some of the nodes in Ring2 and Ring3 are unbuffered.

Each of Ring2 and Ring3 include a plurality of nodes 204. Each node labeled Cbo n (where n is a number) is a node corresponding to a processor core sharing the same number n (as identified by the core's engine number n). There are also other types of nodes shown in system 1100 including UPI nodes 3-0, 3-1, 2-0, and 2-1, an IIO (Integrated IO) node, and PCIe (Peripheral Component Interconnect Express) nodes. Each of UPI nodes 3-0, 3-1, 2-0, and 2-1 is operatively coupled to a respective UPI link interface 3-0, 3-1, 2-0, and 2-1. The IIO node is operatively coupled to an Input/Output interface 1110. Similarly, PCIe nodes are operatively coupled to PCIe interfaces 1112 and 1114. Further shown are a number of nodes marked with an “X”; these nodes are used for timing purposes. It is noted that the UPI, IIO, PCIe and X nodes are merely exemplary of one implementation architecture, whereas other architectures may have more or less of each type of node or none at all. Moreover, other types of nodes (not shown) may also be implemented.

Each of the link interfaces 3-0, 3-1, 2-0, and 2-1 includes circuitry and logic for facilitating transfer of UPI packets between the link interfaces and the UPI nodes they are coupled to. This circuitry includes transmit ports and receive ports, which are depicted as receive ports 1116, 1118, 1120, and 1122, and transmit ports 1124, 1126, 1128, and 1130. As further illustrated, the link interfaces are configured to facilitate communication over UPI links 1131, 1133, and 1135.

System 1100 also shows two additional UPI Agents 1-0 and 1-1, each corresponding to UPI nodes on rings of CPU sockets 0 and 1 (both rings and nodes not shown). As before, each link interface includes an receive port and transmit port, shown as receive ports 1132 and 1134, and transmit ports 1136 and 1138. Further details of system 1100 and a similar system 1100a showing all four Rings0-3 are shown in FIG. 2.

In the context of maintaining cache coherence in a multi-processor (or multi-core) environment, various mechanisms are employed to assure that data does not get corrupted. For example, in system 1100, each of processor cores 1102 corresponding to a given CPU is provided access to a shared memory store associated with that socket, as depicted by memory stores 1140-3 or 1140-2, which typically will comprise one or more banks of dynamic random access memory (DRAM). For simplicity, the memory interface circuitry for facilitating connection to the shared memory store is not shown; rather, the processor cores in each of Ring2 and Ring3 are shown respectively connected to the memory store via a home agent node 2 (HA 2) and a home agent node 3 (HA 3).

As each of the processor cores executes its respective code, various memory accesses will be performed. As is well known, modern processors employ one or more levels of memory cache to store cached memory lines closer to the core, thus enabling faster access to such memory. However, this entails copying memory from the shared (i.e., main) memory store to a local cache, meaning multiple copies of the same memory line may be present in the system. To maintain memory integrity, a cache coherency protocol is employed, such as MESI discussed above.

It is also common to have multiple levels of caches, with caches closest to the processor core having the least latency and smallest size, and the caches further away being larger but having more latency. For example, a typical configuration might employ first and second level caches, commonly referred to as L1 and L2 caches. Another common configuration may further employ a third level or L3 cache.

In the context of system 1100, the highest-level cache is termed the Last Level Cache, or LLC. For example, the LLC for a given core may typically comprise an L3-type cache if L1 and L2 caches are also employed, or an L2-type cache if the only other cache is an L1 cache. Of course, this could be extended to further levels of cache, with the LLC corresponding to the last (i.e., highest) level of cache.

In the illustrated configuration of FIG. 11, each processor core 1102 includes a processing engine 1142 coupled to an L1 or L1/L2 cache 244, which are “private” to that core. Meanwhile, each processor core is also co-located with a “slice” of a distributed LLC 1146, wherein each of the other cores has access to all of the distributed slices. Under one embodiment, the distributed LLC is physically distributed among N cores using N blocks divided by corresponding address ranges. Under this distribution scheme, all N cores communicate with all N LLC slices, using an address hash to find the “home” slice for any given address. Suitable interconnect circuitry is employed for facilitating communication between the cores and the slices; however, such circuitry is not show in FIG. 2 for simplicity and clarity.

As further illustrated, each of nodes 1104 in system 1100 is associated with a cache agent 1148, which is configured to perform messaging relating to signal and data initiation and reception in connection with a coherent cache protocol implemented by the system, wherein each cache agent 1148 handles cache-related operations corresponding to addresses mapped to its collocated LLC 1146. In addition, in one embodiment each of home agents HA2 and HA3 employ respective cache filters 1150 and 1152, and the various caching and home agents access and update cache line usage data stored in a respective directory 1154-2 and 1154-3 that is implemented in a portion of shared memory 1140-2 and 1140-3. It will be recognized by those skilled in the art that other techniques may be used for maintaining information pertaining to cache line usage.

In accordance with one embodiment, a single UPI node may be implemented to interface to a pair of CPU socket-to-socket UPI links to facilitate a pair of UPI links to adjacent sockets. This is logically shown in FIG. 11 by dashed ellipses that encompass a pair of UPI nodes within the same socket, indicating that the pair of nodes may be implemented as a single node.

Generally, any of end-to-end crediting, multi-level crediting, and buffered mesh may be implemented using a ring interconnect structure such as shown in FIG. 11. As with the mesh interconnect, end-to-end is the conventional approach. Under a buffered mesh implementation, the credit loops are between adjacent ring stop nodes. Under multi-level crediting, the credit loops could for longer forwarding paths around the ring could be split into two of more segments.

An example of multi-level crediting is depicted for a message forwarded from ring stop node Cbo 6 to the ring stop node UPI 3-1 in Ring3, which includes a credit loop ‘1’ between ring stop nodes Cbo 6 and Cbo 4, and a credit loop ‘2’ between ring stop nodes Cbo 4 and UPI 3-1. Meanwhile, an example of a buffered mesh (in the context of a ring interconnect) is shown for Ring2, which shows a message being forwarded from ring stop node Cbo 12 to PCIe ring stop node 1156, wherein the forwarding path includes credit loops ‘3’, ‘4’, ‘5’ and ‘6’.

In addition to 2D mesh interconnect topology and ring interconnect topologies, the teachings and principles disclosed herein may be applied to other interconnect topologies, including three-dimensional (3D) topologies. In particular, the buffered mesh approach would be advantageous for 3D, although multi-level crediting could also be implemented, as well as conventional end-to-end crediting.

Buffer Comparison Estimates

FIG. 12 shows a graph illustrating buffer size trends for BL (data buffers) as the mesh topology scales. A symmetric mesh topology is chosen for simplicity of estimates. For simplicity as well, we consider two-level crediting rules instead of multi-level crediting in this graph. Generally, the finer granularity of the credit loops, the better the scaling.

The buffer requirements for end-to-end crediting for source agents is generally OK until 6-7 columns, but scales as O(N³)->N² CHA*2N system agents. By comparison, buffered mesh size is constant with agent scaling—the increase is due to the number of instances only [O(N²)]. Buffered mesh has a trade-off between complexity and buffer size. Dedicated credits per message class has a higher buffer penalty. Shared buffers require less buffers, but implementation complexity increases do to the use of out-of-order queues. While the graph in FIG. 12 does not show TGR scaling with bandwidth, buffered mesh will scale better with bandwidth (lower credit loop) than TGR.

FIG. 13 shows a table 1300 table comparing end-to-end crediting, multi-level crediting, and buffered mesh for power, topology dependence, QoS, idle latency, and loaded latency and throughput. Generally, buffered mesh provides the best feature characteristics, such as best scaling, fine-grain QoS and control, and is independent of topology. However, it may be advantageous to use multi-level crediting or end-to-end crediting under various constraints and other considerations.

A significant aspect of this disclosure is the idea that these credit schemes fall on a continuum where credits can be managed at different levels of granularity based on multiple criteria covering functionality, technical constraints, performance, and cost. This notion is illustrated through the following examples.

First, consider a cache-coherent fabric, which carries requests/responses/snoops/acknowledgments or other types of messages. Each of these channels has different characteristics in terms of their buffering needs, latency and bandwidth requirements, etc. Different crediting schemes can be mixed and matched so as to be best suited to each channel and optimized for the different characteristics of those channels. This leads to a fabric design optimized for latency, bandwidth, power, and area.

Second, consider a multi-core architecture partitioned into multiple tiles, with each tile being connected to its neighbors through a high-speed interface. Such a disaggregated architecture is desirable for “scale-in”, higher die yield, etc. Under one embodiment of such an architecture, each tile could use a fully buffered crediting scheme, while a multi-level crediting scheme could be used between tiles. The architecture could also be disaggregated at other granularities. For example, one or more groups of tiles may use a fully buffered crediting scheme, while other tiles could use a multi-level crediting scheme. End-to-end crediting could also be implemented for transactions between selected tiles or across dies or chips in segregated die or heterogeneous multi-chip packaged systems.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Italicized letters, such as ‘i’, ‘j’, ‘m’, ‘n’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method for implementing credited messages in an interconnect topology comprising a plurality of interconnected nodes integrated on an on-chip die forming an interconnect fabric, comprising:
forwarding a credited message from a first interconnected node comprising a source node to a second interconnect node comprising a destination node along a forwarding path partitioned into a plurality of segments; and
implementing a separate credit loop for each of the plurality of segments.

2. The method of claim 1, wherein the plurality of interconnected nodes is arranged in a two-dimensional mesh interconnect comprising a plurality of rows and columns of interconnected nodes.

3. The method of claim 2, wherein the source node is in a first row and first column and the destination node is in a second row and second column, and wherein the forwarding path includes a first vertical segment from the source node to a second node in the first column and second row, and a second horizontal segment from the second node to the destination node, and wherein a credit loop is implemented for each of the first vertical segment and the second horizontal segment.

4. The method of claim 2, wherein the source node is in a first row and first column and the destination node is in a second row and second column, and wherein the forwarding path includes a first horizontal segment from the source node to a second node in the first row and second column, and a second vertical segment from the second node to the destination node, and wherein a credit loop is implemented for each of the first horizontal segment and the second vertical segment.

5. The method of claim 2, wherein at least a portion of the mesh interconnect is implemented as a buffered mesh under which credit loops are implemented between adjacent pairs of nodes, wherein the forwarding path includes n hops interconnecting n+1 nodes, and wherein a respective credit loop is implemented for each of the n hops.

6. The method of claim 2, wherein the on-chip die includes a plurality of tiles, each associated with a respective mesh stop node, and wherein the credited message is forwarded from a source agent associated with a first tile to a destination agent associated with a second tile.

7. The method of claim 1, wherein the interconnect topology includes a bi-directional ring interconnect structure interconnecting a plurality of ring stop nodes, and wherein the first forwarding path segment traverses a first plurality of ring stop nodes from a source ring stop node to an intermediate ring stop node, and the second forwarding path segment traverses a second plurality of ring stop nodes from the intermediate ring stop node to a destination ring stop node, and wherein a first credit loop is implemented between the source ring stop node and the intermediate ring stop node, and a second credit loop is implemented between the intermediate node and the destination ring stop node.

8. The method of claim 1, wherein the interconnect topology includes a bi-directional ring interconnect structure interconnecting a plurality of ring stop nodes, and wherein respective credit loops are implemented between adjacent ring stop nodes, wherein the forwarding path includes n hops interconnecting n+1 ring stop nodes, and wherein a respective credit loop is implemented for each of the n hops.

9. A System on a Chip (SoC) comprising:
a plurality of interconnected nodes integrated on an on-chip die and configured in an interconnect topology forming an interconnect fabric, wherein each node is interconnected to at least one other node,
wherein the SoC is configured to,
forward a credited message from a first interconnected node comprising a source node to a second interconnect node comprising a destination node along a forwarding path partitioned into a plurality of segments; and
implement a separate credit loop for each of the plurality of segments.

10. The SoC of claim 9, wherein the plurality of interconnected nodes is arranged in a two-dimensional mesh interconnect comprising a plurality of rows and columns of interconnected nodes.

11. The SoC of claim 10, wherein the source node is in a first row and first column and the destination node is in a second row and second column, and wherein the forwarding path includes a first vertical segment from the source node to a second node in the first column and second row, and a second horizontal segment from the second node to the destination node, and wherein a credit loop is implemented for each of the first vertical segment and the second horizontal segment.

12. The SoC of claim 10, wherein the source node is in a first row and first column and the destination node is in a second row and second column, and wherein the forwarding path includes a first horizontal segment from the source node to a second node in the first row and second column, and a second vertical segment from the second node to the destination node, and wherein a credit loop is implemented for each of the first horizontal segment and the second vertical segment.

13. The SoC of claim 10, wherein at least a portion of the mesh interconnect is implemented as a buffered mesh under which credit loops are implemented between adjacent pairs of nodes, wherein the forwarding path includes n hops interconnecting n+1 nodes, and wherein a respective credit loop is implemented for each of the n hops.

14. The SoC of claim 10, wherein the SoC includes a plurality of tiles, each associated with a respective mesh stop node, and wherein the credited message is forwarded from a source agent associated with a first tile to a destination agent associated with a second tile.

15. The SoC of claim 9, wherein the interconnect topology includes a bi-directional ring interconnect structure interconnecting a plurality of ring stop nodes, and wherein the first forwarding path segment traverses a first plurality of ring stop nodes from a source ring stop node to an intermediate ring stop node, and the second forwarding path segment traverses a second plurality of ring stop nodes from the intermediate ring stop node to a destination ring stop node, and wherein a first credit loop is implemented between the source ring stop node and the intermediate ring stop node, and a second credit loop is implemented between the intermediate node and the destination ring stop node.

16. The Soc of claim 9, wherein the interconnect topology includes a bi-directional ring interconnect structure interconnecting a plurality of ring stop nodes, and wherein the SoC is configured to implement respective credit loops between adjacent ring stop nodes, wherein the forwarding path includes n hops interconnecting n+1 ring stop nodes, and wherein a respective credit loop is implemented for each of the n hops.

17. An apparatus comprising:
a System on a Chip (SoC) processor, including,
a plurality of tiles, arranged in a two-dimensional (2D) grid comprising n rows and m columns, each tile comprising at least intellectual property (IP) block;
a mesh interconnect fabric comprising a plurality of interconnected mesh stop nodes configured in a 2D grid comprising n rows and m columns, wherein each mesh stop node is integrated on a respective tile,
wherein the SoC is configured to forward credited messages between mesh stop nodes using forwarding paths partitioned into a plurality of interconnected segments and implement separate credit loops for each of the plurality of interconnected segments.

18. The apparatus of claim 17, wherein the mesh stop nodes in respective rows are interconnected via horizontal ring interconnect structures; and wherein the mesh stop nodes in respective columns are interconnected via vertical ring interconnect structures.

19. The apparatus of claim 17, wherein the SoC is configured to forward a first message from a source agent implemented on a first tile comprising a source agent tile to a destination agent implemented on a second tile comprising a destination tile along a forwarding path, wherein the source agent tile is in a first row and first column and the destination agent tile is in a second row and second column, wherein the forwarding path includes a first vertical segment from the source agent node to a third tile comprising a turn tile in the first column and second row, and a second horizontal segment from the turn tile to the destination agent tile, wherein a first credit loop is implemented between the source agent tile and the turn tile, and a second credit loop is implemented between the turn tile and the destination agent tile.

20. The apparatus of claim 17, wherein the SoC is configured to forward a first message from a source agent implemented on a first tile comprising a source agent tile to a destination agent implemented on a second tile comprising a destination tile along a forwarding path, wherein the source agent tile is in a first row and first column and the destination agent tile is in a second row and second column, wherein the forwarding path includes a first horizontal segment from the source agent node to a third tile comprising a turn tile in the first row and second column, and a second vertical segment from the turn tile to the destination agent tile, wherein a first credit loop is implemented between the source agent tile and the turn tile, and a second credit loop is implemented between the turn tile and the destination agent tile.

21. The apparatus of claim 19, wherein at least a portion of the mesh interconnect fabric is implemented as a buffered mesh under which credit loops are implemented between adjacent pairs of mesh stop nodes for at least one message class.

22. The apparatus of claim 19, wherein credit loops are implemented between adjacent pairs of mesh stop nodes for a plurality of message classes.

23. The apparatus of claim 19, wherein the apparatus comprises a computer system and the IP blocks include a plurality of processor cores, a plurality of caches, at least one memory controller, and a plurality of Input-Output (IO) interfaces, the apparatus further comprising:
a plurality of Dual In-line Memory Modules (DIMMs) communicatively coupled to the at least one memory controller via one or more memory channels; and
a firmware storage device, coupled to one of the plurality of IO interfaces.

24. The apparatus of claim 23, wherein memory in the plurality of DIMMs comprises system memory, wherein the computer system is configured to implement a memory coherency protocol to maintain memory coherency between data stored in the plurality of caches and the system memory using one or more classes of messages that are forwarded between caching agents using forwarding paths partitioned into a plurality of interconnected segments and implementing separate credit loops for each of the plurality of interconnected segments.

25. The apparatus of claim 19, wherein at least a portion of the tiles have associated source agents that are configured to implement source throttling to prevent slower source agents from flooding the mesh interconnect fabric.
